(19) United States
(12) Patent Application Publication
(10) Pub. No.: US 2013/0153064 A1
(43) Pub. Date: Jun. 20, 2013

(54) Brazed assembly and method of forming

(71) Applicants: Marvin McKimpson, Metamora, IL (US); Kevin Dammann, Peoria, IL (US); Bao Feng, Dunlap, IL (US); Ryan Johnson, Ransom, IL (US); Ronald Shinogle, Peoria, IL (US); Donald Stickel, Chillicothe, IL (US); Michael Vogler, Peoria, IL (US)

(72) Inventors: Marvin McKimpson, Metamora, IL (US); Kevin Dammann, Peoria, IL (US); Bao Feng, Dunlap, IL (US); Ryan Johnson, Ransom, IL (US); Ronald Shinogle, Peoria, IL (US); Donald Stickel, Chillicothe, IL (US); Michael Vogler, Peoria, IL (US)

(73) Assignee: CATERPILLAR INC., Peoria, IL (US)

(21) Appl. No.: 13/327,214

(22) Filed: Dec. 15, 2011

(51) Int. Cl. F15D 1/00; B23K 1/20; B23K 1/00

(52) U.S. Cl. 137/561 R; 228/101; 228/246; 228/174; 228/170

(57) ABSTRACT

An assembly includes a first plate member with a first generally planar abutting surface and a second plate member with a second generally planar abutting surface. The first abutting surface being generally planar and having a plurality of micro reservoirs for storing brazing material. The first abutting surface and the second abutting surface being positioned adjacent each other and being joined by brazing material from the plurality of micro reservoirs.

### TECHNICAL FIELD

This disclosure relates generally to assemblies formed by brazing and, more particularly, to an assembly in which brazing material is stored adjacent the brazed connection and a method of forming such assembly.

### BACKGROUND

Machines often use fluid operated systems for controlling various implement systems of the machine. Such fluid operated systems typically include a control system having one or more control valve assemblies for controlling the flow of hydraulic fluid to and from the implement systems. The control valve assemblies generally include a valve body with a plurality of passages and one or more valve members moveably mounted so as to control the rate of flow through one or more of the passages. The control valve assemblies are often utilized to direct or control the flow of hydraulic fluid having a pressure as high as 5,000 psi. In some instances, the valve bodies are cast with a series of internal passages. In other instances, the valve bodies may be formed of a plurality of plates that are stacked together and oriented such that each plate forms a linear segment along each of the internal passages. In each case, the shape of the internal passages may be limited by the process of forming the valve body.

U.S. Pat. No. 6,305,418 discloses a hydraulic valve that is formed from a plurality of parallel, plate-shaped metal sheets. The metal sheets are brazed together to form the assembly. The metal sheets include holes that are aligned to form segments of the internal passages along their linear axes. Reception channels for brazing material extend over the entire length between end plates of the assembly. Fixing posts may also extend between the end plates to align the sheet metal plates.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

An assembly formed by brazing two or more components together is provided. In one aspect, the assembly includes a first plate member with a first generally planar abutting surface and a second plate member with a second generally planar abutting surface. One of the first abutting surface and the second abutting surface has a plurality of micro reservoirs for storing brazing material. The first abutting surface and the second abutting surface are positioned adjacent each other and are joined by the brazing material.

In another aspect, a method of forming an assembly includes providing a first plate member with a generally planar first abutting surface. The first abutting surface has a plurality of micro reservoirs. Brazing material is inserted into the micro reservoirs. A second plate member with a generally planar second abutting surface is provided. The first plate member and second plate member are positioned with the first abutting surface adjacent the second abutting surface. A brazing material is provided between the first plate member and the second plate member. The first plate member, the second plate member, the brazing layer and the brazing material are heated to braze the first plate member to the second plate member.

### BRIEF DESCRIPTION OF THE DRAWINGS

FIG. 1 is a side view of an excavator that may incorporate the concepts disclosed herein;

FIG. 2 is a perspective view of a hydraulic valve assembly that may be used with the excavator of FIG. 1 and incorporates the concepts disclosed herein;

FIG. 3 is a sectional view taken generally along line 3-3 of FIG. 2 with only some components shown in section for clarity;

FIG. 4 is a view similar to FIG. 3 but with the components removed to show the first plate member;

FIG. 5 is a perspective view of the first plate member of FIG. 4 with a solder layer located thereon;

FIG. 6 is a perspective view of the first and second plate members aligned and prior to being positioned adjacent to each other for brazing;

FIG. 7 is a schematic illustration of a section of the first and second plate members according to a first embodiment;

FIG. 8 is a schematic illustration of a section of the first and second plate members according to a second embodiment;

FIG. 9 is a schematic illustration of a section of the first and second plate members according to a third embodiment;

FIG. 10 is a schematic illustration of a section of the first and second plate members according to a fourth embodiment; and

FIG. 11 is a flow diagram illustrating a process for brazing the first plate member to the second plate member.

### DETAILED DESCRIPTION

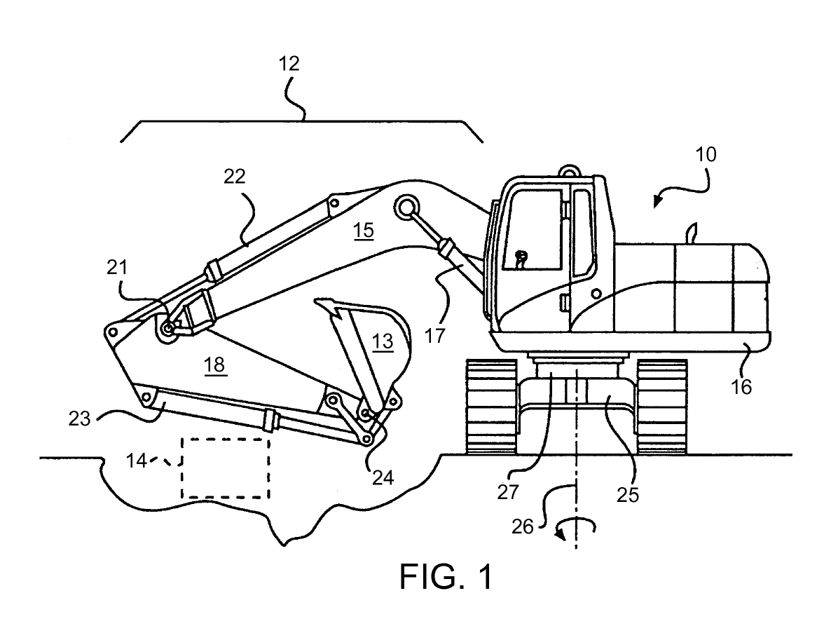

FIG. 1 illustrates an exemplary machine 10 having multiple systems and components that cooperate to excavate and load earthen material onto a nearby target machine such as a haul vehicle (not shown). In one example, machine 10 may embody a hydraulic excavator. It is contemplated, however, that machine 10 may embody other types of machines, whether movable or stationary. Machine 10 may include, among other things, an implement system 12 configured to move a work tool 13 between a first position such as a dig location 14 and a second position such as a dump location (not shown).

Implement system 12 may include a linkage structure utilizing fluid actuators to move work tool 13. More specifically, implement system 12 may include a boom member 15 vertically pivotal relative to frame 16 and propelled by a pair of adjacent, double-acting, boom hydraulic cylinders 17 (only one being shown in FIG. 1). Implement system 12 may also include a stick member 18 vertically pivotal about a horizontal axis 21 between boom member 15 and stick member 18 and propelled by a single, double-acting, stick hydraulic cylinder 22. Implement system 12 may further include a single, double-acting, work tool hydraulic cylinder 23 operatively connected to work tool 13 to pivot work tool 13 vertically about a horizontal axis 24 through stick member 18 and work tool 13. Frame 16 may be horizontally pivotally connected relative to an undercarriage member 25, and moved about vertical axis 26 by a swing motor 27.

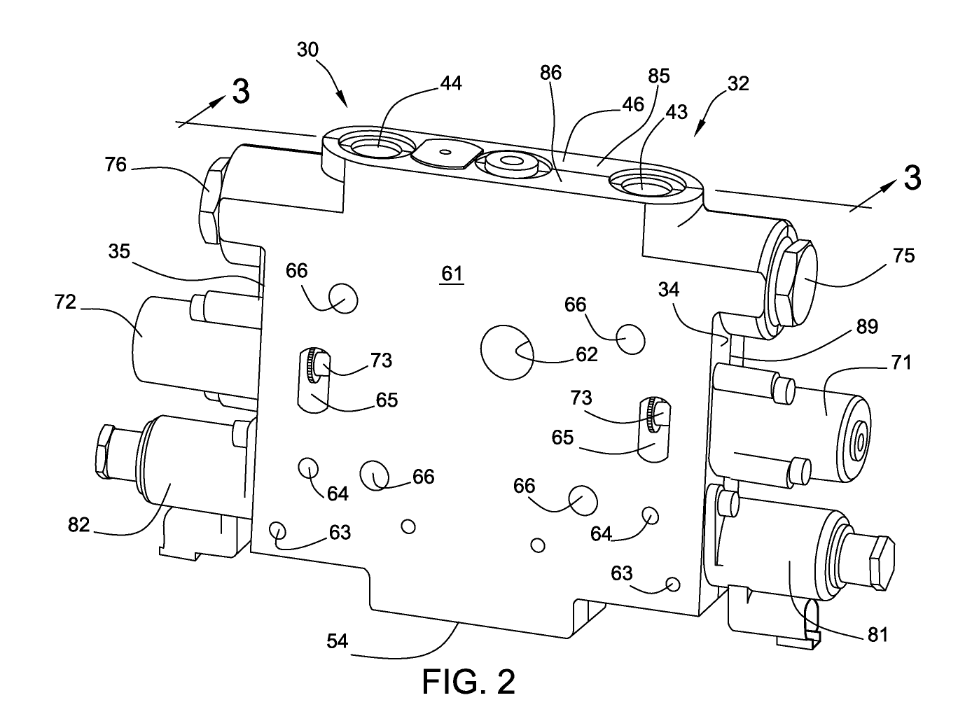

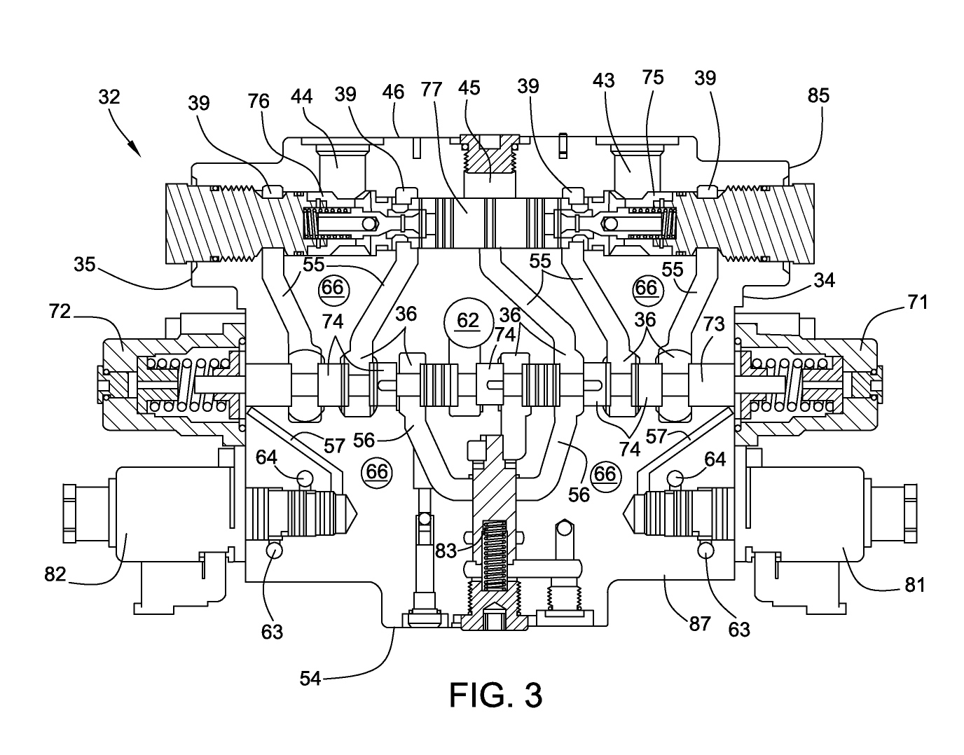

Each of the hydraulic cylinders and the swing motor may be driven by pressurized fluid such as hydraulic fluid. Flow of hydraulic fluid such as oil to and from the fluid actuators may be controlled by one or more hydraulic valve assemblies 30 as depicted in FIGS. 2-3. Hydraulic valve assembly 30 has a two-piece housing or valve body 32 with a plurality of passages such as bores, flow passages, ports, cavities and other openings, recesses and voids therein.

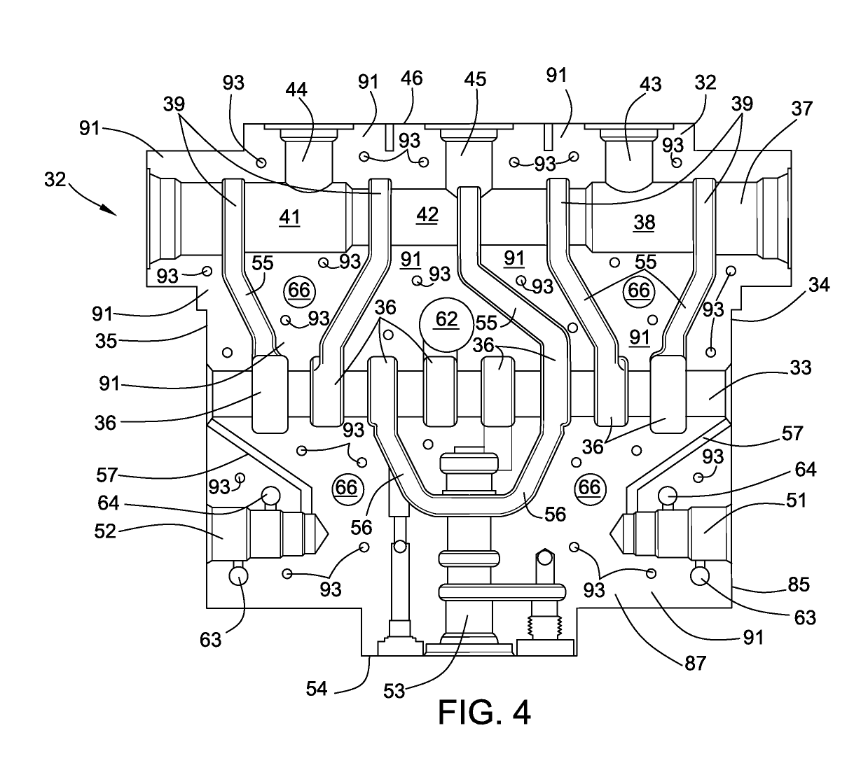

More specifically, referring to FIGS. 3-4, valve body 32 may have a first bore such as central spool bore 33 that extends from a first side 34 of valve body 32 to a second side 35 of the valve body. Central spool bore 33 (shown in FIG. 4) may be generally cylindrical with a plurality of spaced apart, enlarged sections such as central annuluses 36. Valve body 32 may further include a second bore such as additional bore 37 that is generally parallel to and spaced from central spool bore 33. Additional bore 37 may have a first cartridge cavity 38 adjacent the first side 34 of valve body 32, a second cartridge cavity 41 adjacent the second side 35 of valve body 32 and an additional spool bore 42 between the first cartridge cavity 38 and the second cartridge cavity 41. A first work port 43 may extend inwardly from a work surface 46 and is in fluid communication with first cartridge cavity 38. A second work port 44 may extend inwardly from work surface 46 and is in fluid communication with second cartridge cavity 41. An additional end bore 45 may be positioned between the first work port 43 and the second work port 44 and extends inwardly from the work surface 46 and is in fluid communication with the additional spool bore 42.

A first solenoid cavity 51 may extend inwardly from first side 34 of valve body 32 towards the second side 35 of the valve body and a second solenoid cavity 52 may extend inwardly from second side 35 of the valve body towards the first solenoid cavity 51. The central spool bore 33 may be positioned between the additional bore 37 and the pair of aligned solenoid cavities. A compensator bore 53 may extend inwardly from a compensator surface 54 that faces in a direction opposite work surface 46 and towards central spool bore 33.

A plurality of flow passages may be provided within the valve body 32 to connect the central spool bore 33, the additional bore 37, the first solenoid cavity 51, the second solenoid cavity 52 and the compensator bore 53. More specifically, a plurality of first flow passages 55 may extend between and fluidly connect some of the central annuluses 36 of the central spool bore 33 and the additional annuluses 39 of the additional bore 37. Second flow passages 56 may extend between and fluidly connect the compensator bore 53 and others of the central annuluses 36 of the central spool bore 33. A third flow passage 57 may extend between and fluidly connect first solenoid cavity 51 and the first side 34 of valve body 32 adjacent central spool bore 33 for providing hydraulic fluid to first spool bore actuator 71 (FIG. 3). An additional third flow passage 57 may extend between and fluidly connect the second solenoid cavity 52 and the second side 35 of valve body 32 to provide hydraulic fluid to the second spool bore actuator 72.

A plurality of holes or passages may be provided in one or both outer faces 61 (only one face being visible in FIG. 2). Pump passage 62 may extend from outer face 61 of valve body 32 and fluidly connect a fluid pump (not shown) to one of the central annuluses 36 of the central spool bore 33. Spool bore actuator flow may be provided through first supply bore 63 and second supply bore 64 that are fluidly connected to each of the first solenoid cavity 51 and the second solenoid cavity 52. In addition, tank passage openings 65 may extend from a central annulus 36 of central spool bore 33 to outer face 61. Still further, connection holes 66 may extend through valve body 32 to permit adjacent hydraulic valve assemblies 30 to be secured together. Connection holes 66 do not intersect with any of the bores or flow passages or other sections through which hydraulic fluid flows.

A first shaft such as central shaft 73 may be slidably positioned within central spool bore 33. Central shaft 73 may be generally cylindrical and include enlarged areas such as shaft annuluses 74. Opposite ends of the central shaft 73 are connected to the first spool bore actuator 71 and the second spool bore actuator 72, respectively, to control movement of the central shaft 73. Movement of the central shaft 73 directs hydraulic fluid to selected ones of the flow passages and permits hydraulic fluid to selectively flow from the valve body 32 through the first work port 43 and the second work port 44. A first lock valve assembly 75 may be positioned within first cartridge cavity 38 and a second lock valve assembly 76 may be positioned within the second cartridge cavity 41. An additional spool 77 may be positioned within additional spool bore 42. First lock valve assembly 75, second lock valve assembly 76 and additional spool 77 may operate to control the flow of hydraulic fluid to and from a fluid actuator (not shown) connected to hydraulic valve assembly 30.

A first solenoid 81 may be positioned along first side 34 of valve body 32 with a portion thereof extending into the first solenoid cavity 51 to control the flow of hydraulic fluid to the first spool bore actuator 71. A second solenoid 82 may be positioned along second side 35 of valve body 32 with a portion extending into the second solenoid cavity 52 to control the flow of hydraulic fluid to second spool bore actuator 72. A compensator 83 may be positioned within compensator bore 53 to further control the flow of hydraulic fluid between adjacent hydraulic valve assemblies 30.

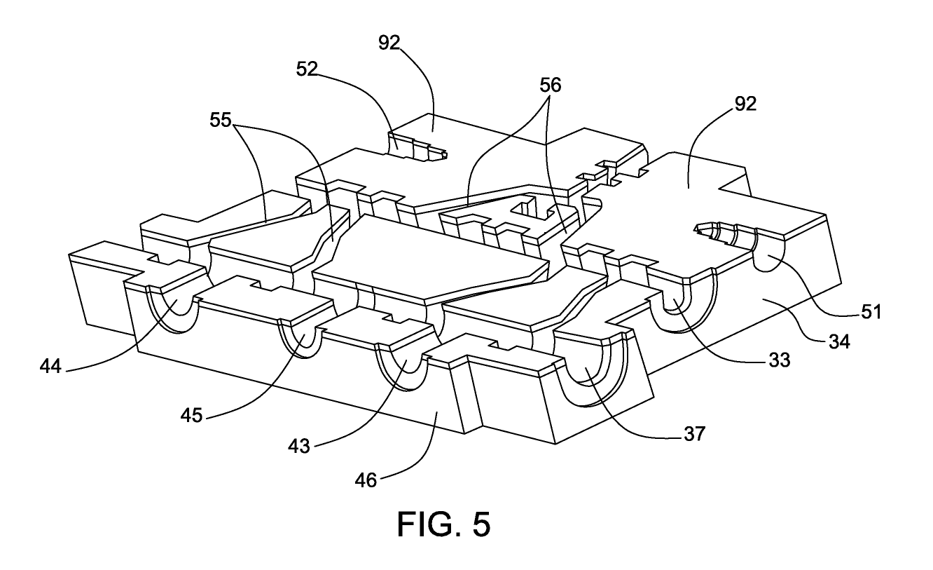

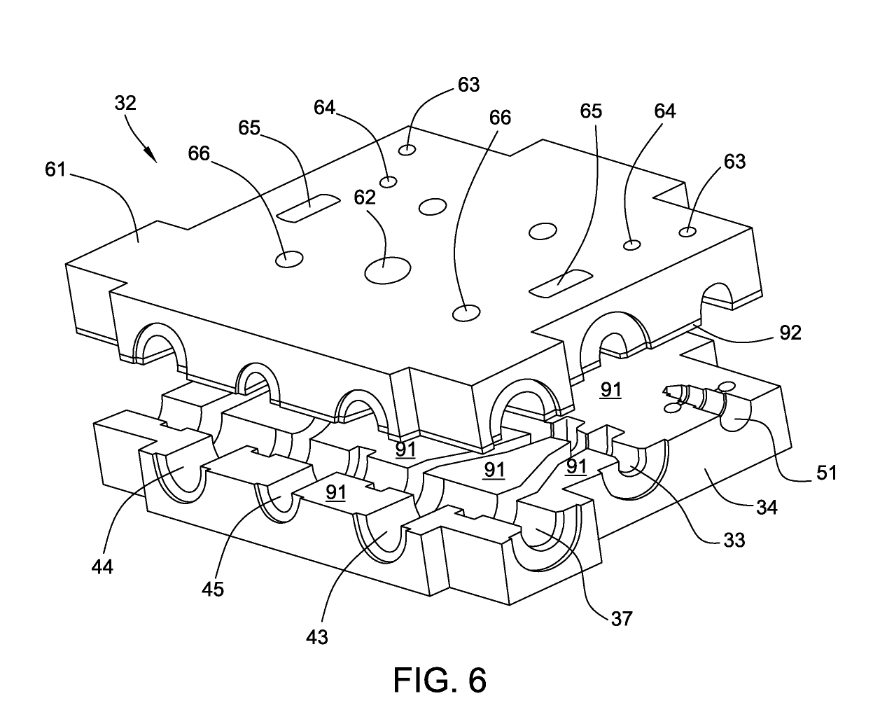

From the foregoing, it can be seen that valve body 32 includes a complex array of passages such as bores, flow passages, ports, cavities and other openings through which hydraulic fluid may flow at relatively high pressures. In one example, the pressure of hydraulic fluid flowing through the hydraulic valve assembly 30 may range from approximately 0 to at least 4,000 psi and may be as high as 5,000 psi. As depicted, valve body 32 may be formed from two or more plate members that are secured together through a brazing process. In the embodiment depicted in FIGS. 2-6, a first plate member 85 is connected or joined to a second plate member 86 to form the valve body 32. If desired, the first plate member 85 and the second plate member 86 may be substantially identical with a first abutting surface 87 of the first plate member 85 and the second abutting surface 88 of the second plate member 86 being positioned adjacent each other and connected or joined at a connection plane 89. In an alternate embodiment, the valve body may be divided into three or more plate members.

In such a configuration, the connection plane 89 may bisect each of the central spool bore 33, the additional bore 37, the first work port 43, the second work port 44, the additional end bore 45, the first solenoid cavity 51, the second solenoid cavity 52, the compensator bore 53, the first flow passages 55, the second flow passages 56, and the third flow passages 57. In this way, each of those passages may have a segment or portion of their shape intersecting with each of the first abutting surface 87 and second abutting surface 88 so as to form the complete shape of each passage upon brazing the first plate member 85 to the second plate member 86. In some configurations, all or some of the passages of valve body 32 may be formed in one of the first abutting surface 87 or the second abutting surface 88 so that the first plate member 85 and the second plate member 86 are not substantially identical. In other words, it may be possible to form all or some of the passages in one of the abutting surfaces while leaving the other abutting surface generally planar.

As best seen in FIG. 4, the various passages extending along and into the first abutting surface 87 and the second abutting surface 88 divide the respective abutting surfaces into a plurality of abutting regions 91 with each abutting region being adjacent at least two of the passages. When brazing the first plate member 85 to the second plate member 86, brazing material is provided to each of the abutting regions 91. Due to the passages separating the abutting regions, brazing material may not be able to flow between adjacent abutting regions.

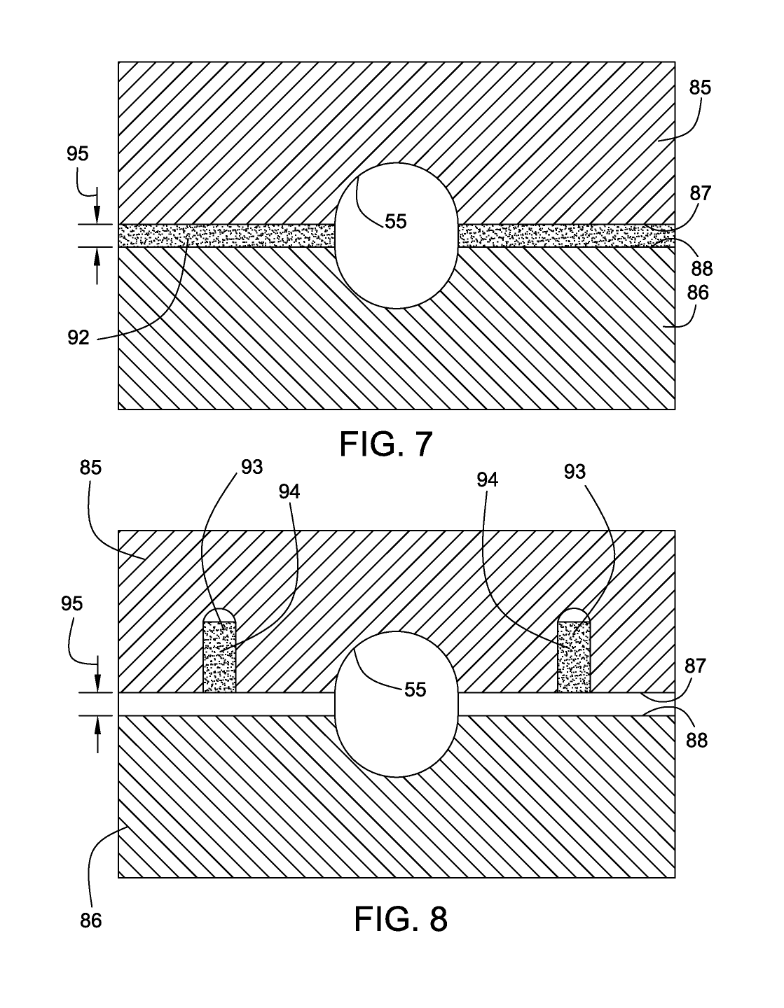

As best seen in FIG. 7, immediately prior to the brazing process, the first plate member 85 and the second plate member 86 may be positioned so that a gap 95 is formed between the first abutting surface 87 and the second abutting surface 88. The first plate member 85 and the second plate member 86 may be fixed at this position during the brazing process and brazing material provided to fill the gap and join the first plate member 85 to the second plate member 86. In an embodiment, brazing material may be provided in the form of layer of brazing material such as a brazing foil 92 positioned in the gap 95 between the first abutting surface 87 and the second abutting surface 88. Brazing foil 92 may be made of a copper alloy or another appropriate material. If desired, the layer of brazing may be another material such as a layer of brazing paste.

Upon heating the first plate member 85, the second plate member 86, and the brazing foil 92 to an appropriate temperature in an appropriate environment, the brazing foil melts and flows along the connection plane 89. This joins the first plate member 85 and the second plate member 86 together along the abutting regions 91. At locations at which segments of passages along the first abutting surface 87 are adjacent segments of passages of the second abutting surface 88, the segments will be joined and sealed along the edges of the segments. In other words, where a first segment of a passage in the first abutting surface 87 and a second segment of a passage in the second abutting surface 88 are aligned, brazing the first plate member 85 to the second plate member 86 will cause the brazing foil to seal the passage along edges of the first segment and the second segment.

As depicted in FIGS. 4 and 8-10, a plurality of bores or micro reservoirs 93 may be provided in each of the abutting regions 91 to fill gap 95. Such micro reservoirs 93 may have brazing material such as a brazing wire 94 inserted therein. Brazing wire 94 may be a copper alloy or another appropriate material. If desired, micro reservoirs 93 may be filled with other types of brazing material such a brazing paste. During the process of joining the first plate member 85 to the second plate member 86, the first plate member and the second plate member are heated to a desired temperature within the desired environment and the brazing material within each micro reservoir 93 melts and the brazing material flows or wicks to the abutting regions 91 of each of the first abutting surface 87 and the second abutting surface 88 to join the first plate member 85 to the second plate member 86.

The dimensions such as the size and depth of the micro reservoirs 93 may be set based upon a number of factors including the size of the gap 95 between the first abutting surface 87 and the second abutting surface 88 as well as the surface area of the first abutting surface and the second abutting surface. Since each opening along the abutting surfaces may reduce the strength of the joint between the abutting surfaces, in some situations it may be desirable to minimize the size and number of the micro reservoirs 93 to maximize the strength of the connection between the first plate member 85 and the second plate member 86.

In one example, it is believed that for a first plate member 85 and a second plate member 86 having approximate dimensions of 200 mm by 300 mm and with the passages depicted in FIG. 4, it may be desirable to utilize micro reservoirs 93 having a diameter of approximately 2.5 mm. Depending upon the configuration of the passages and the abutting regions 91, the micro reservoirs 93 may have other diameters such as, for example, between approximately 2.0 mm and 5.0 mm. The depth of the micro reservoirs 93 may be set so as to maximize the amount of brazing material stored to minimize the number of micro reservoirs and thus the number of interruptions within the brazed joint therein. By minimizing, the number of micro reservoirs and thus interruptions, the joint strength between the first plate member 85 and the second plate member 86 may be maximized. In one example, it is believed that the depth of the micro reservoirs 93 may have a depth between approximately 3.0 mm and 10.0 mm. The micro reservoirs 93 have a cross-sectional area along the first abutting surface 87 and define a total area of micro reservoirs equal to the area of each micro reservoir times the number of micro reservoirs. For the configuration depicted in FIGS. 3-4, it is believed that it is desirable for the density of micro reservoirs 93 to be less than approximately five percent of the total area of the first abutting surface 87. In some circumstances, it may be desirable for the total area of micro reservoirs 93 to be a lower percentage, such as approximately two percent or less.

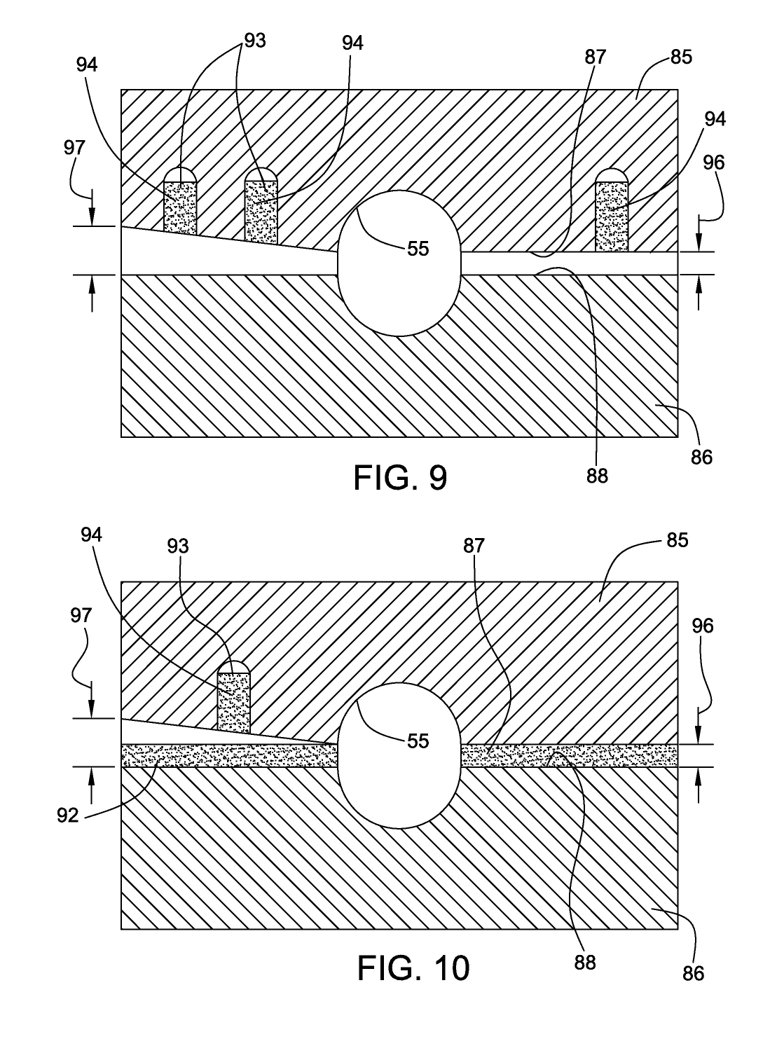

If desired, the number of micro reservoirs 93 within each abutting region 91 may be set so at to provide a uniform density of micro reservoirs within each abutting region 91. However, in some instances, the gap between the first plate member 85 and the second plate member 86 may not be uniform throughout each of the abutting regions 91. Referring to FIG. 9, a first gap 96 of a first thickness exists between the first plate member 85 and the second plate member 86 at a first abutting region while a second gap 97 of a second thickness exists between the first plate member 85 and the second plate member 86 at a second abutting region. The second gap 97 is depicted as being larger than the first gap 96 so that the joint of brazing material between the first plate member 85 and the second plate member 86 has a non-uniform thickness. In such case, it may be desirable to provide micro reservoirs 93 in a non-uniform density within each abutting region so as to provide additional brazing material at those abutting regions 91 that have a larger gap. This results in a greater thickness of brazing material at the location of the second gap 97. In addition, there may be other reasons for providing non-uniform density of micro reservoirs 93 such as a situation in which a shape of a particular abutting region makes additional brazing material desirable.

In still another embodiment, the brazing foil 92 may be combined with the use of micro reservoirs 93. For example, in the case of a second gap 97 being larger than the first gap 96 depicted in FIG. 10, it may be desirable to utilize brazing foil 92 along all or substantially all of the connection plane 89 and supplement or add additional brazing material at certain abutting regions 91 through the use of micro reservoirs 93 at those abutting regions. Still further, it may desirable to utilize brazing foil 92 over only certain abutting regions 91 and micro reservoirs 93 over other abutting regions.

Although described in the context of a hydraulic valve assembly 30 and valve body 32, the principles disclosed herein are equally applicable to any assembly in which two members are joined by brazing. The flexibility of utilizing non-uniform densities of micro reservoirs 93 or micro reservoirs in combination with brazing foil 92 or a layer of brazing material may be particularly useful in a number of situations. For example, the shape of the abutting surfaces may make a non-uniform distribution of brazing material desirable. In another example, some components may be relatively difficult to clamp together or may be substantially inflexible so as to create a non-uniform gap between the components when clamped together or when heated to a brazing temperature. In each of these examples, a non-uniform application of brazing material may be useful to create a desired joint of brazing material.

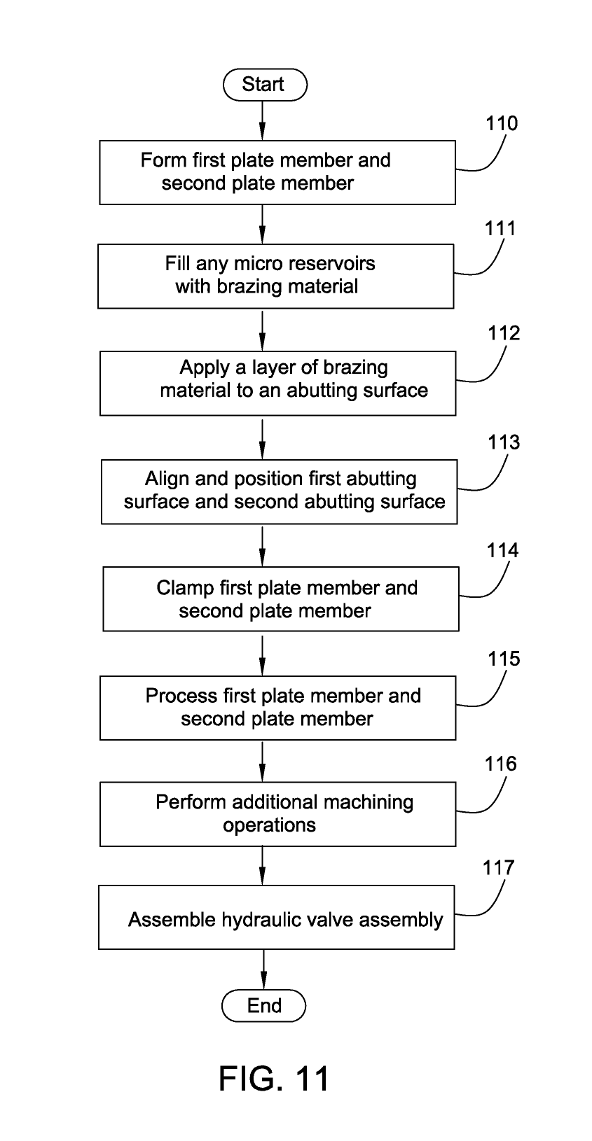

Referring to FIG. 11, a flowchart of the process for manufacturing the hydraulic valve assembly 30 is depicted. At stage 110, the first plate member 85 and the second plate member 86 are formed. The plate members may be cast from castable materials such as cast iron or by machining the plate members out of plate material such as steel. If the plate members are cast, subsequent machining operations (including machining of micro reservoirs 93) may be necessary. After the first plate member 85 and the second plate member 86 are fully formed, any micro reservoirs 93 that have been formed are filled with brazing material such as brazing wire 94 at stage 111. A layer of brazing material such as brazing foil 92, if used, may be applied to one of the abutting surfaces at stage 112. In some instances, it may be desirable to form the micro reservoirs 93 in the first abutting surface 87 and also apply the layer of brazing material to the first abutting surface 87. In other instances, it may be desirable for the micro reservoirs 93 and the layer of brazing material to be applied to different abutting surfaces.

At stage 113, the first plate member 85 and the second plate member 86 are aligned and positioned so that the first abutting surface 87 and the second abutting surface 88 are aligned a predetermined distance apart. At stage 114, the first plate member 85 and the second plate member 86 may be fixedly secured within an appropriate alignment fixture (not shown), clamped or otherwise secured to maintain the desired alignment and spacing between the first plate member 85 and the second plate member 86. The assembled first plate member 85 and the second plate member 86 may be processed at stage 115 through an appropriate furnace brazing operation so as to create a reliable joint along the connection plane 89 to join the first plate member 85 and the second plate member 86 and seal the edges of the passages to permit fluid to flow therethrough. It may be desirable to orient the first plate member 85, the second plate member 86 and their associated micro reservoirs 93 and the layer of brazing material so that the effects of gravity operate in a beneficial manner. For example, micro reservoirs 93 and the layer of brazing material may be applied to first abutting surface 87 and the first plate member 85 positioned on top of the second plate member 86 during the furnace brazing operation.

After the first plate member 85 and the second plate member 86 are brazed together to form valve body 32, additional machining operations may occur at stage 116. Various components such as the first spool bore actuator 71, the second spool bore actuator 72, the central shaft 73, the first lock valve assembly 75, the second lock valve assembly 76, the additional spool 77, the first solenoid 81, the second solenoid 82 and the compensator 83 may be mounted within and on the valve body 32 at stage 117 to assemble the hydraulic valve assembly 30.

In an alternate process, the first plate member 85 and the second plate member 86 may be slidably mounted so as to permit the first plate member and the second plate member to move closer to each other during the furnace brazing operation. That is, the first plate member 85 and the second plate member 86 may be spaced a first distance apart but may slide relative to each other during the furnace brazing operation to move closer together and reduce the distance between the two plate members.

### INDUSTRIAL APPLICABILITY

The industrial applicability of the assembly described herein will be readily appreciated from the foregoing discussion. The foregoing discussion is applicable to assemblies that are formed from two or more plate members that are brazed together. In one example, the assembly may be formed of two plate members that are substantially inflexible and may have a gap between the plate members with a non-uniform thickness. The structure described herein permits a reliable brazing joint even with a non-uniform gap between the plate members. In other another example, a valve body 32 has passages through which hydraulic fluid may flow under high pressure. By forming the valve body 32 from a first plate member 85 and a second plate member 86, the passages within the plate members may be more easily and/or accurately formed. In addition, such a multi-component configuration may permit passages to be formed with shapes that permit more efficient fluid flow through the hydraulic valve assembly 30 and may permit passages to be formed with shapes that cannot be formed or may be more difficult to form with a one-piece valve body. In other words, forming the passages along the first and second abutting surfaces may provide additional flexibility with respect to the shapes of passages within valve body 32. Such access may be utilized to form more complex passages or more efficient passages to reduce pressure drop within the valve body 32.

In one aspect, the assembly includes a first plate member 85 with a first abutting surface 87 and a second plate member with a second abutting surface 88. One of the first abutting surface 87 and the second abutting surface 88 has a plurality of micro reservoirs 93 for storing brazing material prior to a process for joining the first abutting surface 87 and second abutting surface 88. The first abutting surface 87 and the second abutting surface 88 are positioned adjacent each other and are joined by the brazing material.

In another aspect, a method of forming an assembly includes providing a first plate member 85 with a generally planar first abutting surface 87. The first abutting surface 87 has a plurality of micro reservoirs 93. Brazing material is inserted into the micro reservoirs 93. A second plate member 86 with a generally planar second abutting surface 88 is provided. The first plate member 85 and second plate member 86 are positioned with the first abutting surface adjacent the second abutting surface. A brazing material is provided between the first plate member 85 and the second plate member 86. The first plate member 85, the second plate member 86, the brazing layer and the brazing material are heated to braze the first plate member to the second plate member.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An assembly comprising:
a first plate member with a first abutting surface, the first abutting surface being generally planar and having a plurality of micro reservoirs for storing brazing material;
a second plate member with a second abutting surface, the second abutting surface being generally planar;
the first abutting surface and the second abutting surface being positioned adjacent each other and being joined by brazing material from the plurality of micro reservoirs.

2. The assembly according to claim 1, wherein the first abutting surface and the second abutting surface are joined by a layer of brazing material, the layer of brazing material has a non-uniform thickness, and areas of greater thickness are adjacent at least one of the micro reservoirs.

3. The assembly according to claim 1, wherein the first abutting surface has a non-uniform array of micro reservoirs therein.

4. The assembly according to claim 1, wherein the first plate member and the second plate member are each substantially inflexible.

5. The assembly according to claim 1, wherein the micro reservoirs have a diameter of between approximately 2.0 mm and 5.0 mm and have a depth of between approximately 3.0 mm and 10.0 mm.

6. The assembly according to claim 1, wherein each micro reservoir has a cross-sectional area along the first abutting surface and the plurality of micro reservoirs define a total area of micro reservoirs, the total area of micro reservoirs being less than five percent of a total area of the first abutting surface.

7. The assembly according to claim 6, wherein the total area of micro reservoirs is less than approximately two percent of a total area of the first abutting surface.

8. The assembly according to claim 1, wherein the assembly includes a hydraulic valve assembly having a valve body, the valve body including a first bore, a second bore, a plurality of flow passages fluidly connecting the first bore and the second bore, and a plurality of ports through which hydraulic fluid may selectively flow to and from the valve body, and a first shaft slidably positioned within the first bore, wherein movement of the first shaft directs hydraulic fluid to selected ones of the plurality of flow passages.

9. The assembly according to claim 8, wherein the micro reservoirs have a diameter of between approximately 2.0 mm and 5.0 mm and have a depth of between approximately 3.0 mm and 10 mm.

10. The assembly according to claim 8, wherein the first abutting surface and the second abutting surface are joined at a connection plane, the connection plane extending through the plurality of ports.

11. The assembly according to claim 10, wherein the connection plane extends through at least some of the flow passages.

12. The assembly according to claim 11, wherein the connection plane extends through the first bore and the second bore.

13. The assembly according to claim 8, wherein the hydraulic valve assembly is configured to direct hydraulic fluid at a pressure of between approximately 0 and at least 4000 psi.

14. A method of forming an assembly, comprising the steps of:
providing a first plate member with a first abutting surface, the first abutting surface being generally planar and having a plurality of micro reservoirs therein;
inserting brazing material in the micro reservoirs;
providing a second plate member with a second abutting surface, the second abutting surface being generally planar;
positioning the first plate member and the second plate member with the first abutting surface adjacent the second abutting surface;
providing a brazing layer between the first plate member and the second plate member; and
heating the first plate member, the second plate member, the brazing layer, and the brazing material to braze the first plate member to the second plate member.

15. The method of claim 14, wherein the inserting step includes inserting a brazing wire into each micro reservoir.

16. The method of claim 14, further including fixedly securing the first plate member and the second plate member relative to each other prior to the heating step to define a gap between the first plate member and the second plate member.

17. The method of claim 14, further including slidably securing the first plate member and the second plate member relative to each other prior to the heating step to define a first distance between the first plate member and the second plate member and moving the first plate member and the second plate member during the heating step to define a second distance between the first plate member and the second plate member.

18. The method of claim 14, further including forming a first segment of a passage in the first abutting surface and a second segment of the passage in the second abutting surface and sealing edges of the first segment and the second segment upon brazing the first plate member to the second plate member.

19. The method of claim 18, further including casting the first plate member and the second plate member with the first segment and the second segment formed during the casting step.

20. The method of claim 18, further including machining the first segment and the second segment prior to the positioning step.
